(19) United States
(12) Patent Application Publication
(10) Pub. No.: US 2005/0149560 A1
(43) Pub. Date: Jul. 7, 2005

(54) Digital transmission device

(76) Inventor: Jao-Ching Lin, Hsin Chuang (TW)

Correspondence Address: G Link Co Ltd, 3550 Bell Road, Minooka, IL, 60447, US

(21) Appl. No.: 10/747,480

(22) Filed: Dec. 25, 2003

(51) Int. Cl. G06F 7/00

(52) U.S. Cl. 707/104.1

(57) ABSTRACT

A digital transmitting device includes at least a main body, a controller, a display unit and a registering medium. The controller, the display unit and the registering medium are coupled to the main body. The controller further includes an input unit controlled by the controller to perform an execute instruction and a transmitting unit receiving or transmitting digital name card data such as characters, graphic files and images. The received digital name card data can be saved in the registering medium and/or transmitted to a corresponding external electronic device.

### BACKGROUND OF THE INVENTION

1. Field of the Invention

This invention is related to a digital transmitting device, in particular to a device, which can send digital electronic name card data to a corresponding electronic device by way of wireless and/or wire transmission.

2. Description of the Related Art

To exchange or transfer conventional name cards is indispensable way of mutual recognitions in the contemporary human relationship. Each conventional name card mostly is made of paper or plastics with personal communication data on it to identify the person of the name card. However, it is easy to occur a problem of environmental protection regardless the name card is a piece of paper or plastics. In addition, more name cards have to be collected after a long period to result in trouble and inconvenience to the user for placing the huge name cards and finding a specific name card. Furthermore, the exchanged name cards may have been changed the content thereof or repeatedly changed so that it is very likely to generate puzzle and trouble while the name cards are rearranged and managed afterward.

In order to solve the preceding problems, usually, a notebook or a personal digital assistance (abbreviated as PDA) is used for simply managing the data. However, the data on the name card has to be keyed in the notebook or the PDA one at a time and the keyed in data is limited to text data. It is not possible for the graphic data such as company logos and personal pictures to be input. Hence, it is still has deficiency to save the name card data with the notebook or the PDA.

Accordingly, a name card scanner is developed and the name card scanner is connected to a computer with wire and the computer is loaded with scan recognition software. In this way, the name card data can be digitally saved in the computer through the scan recognition software. Further, the notebook or the PDA is connected to the computer main unit with the wire so as to download the digital name card data. However, the scanned digital name card data only can be saved in the notebook or PDA alone and it is not possible to transmit the data directly to others. The name card scanner still has its shortcoming in use.

### SUMMARY OF THE INVENTION

The crux of the present invention is in that a digital transmitting device is provided and the digital transmitting device includes at least a main body, a controller, a display unit and a registering medium. The controller, the display unit and the registering medium are coupled to the main body. The controller further includes an input unit controlled by the controller to perform an execute instruction and a transmitting unit receiving or transmitting digital name card data such as characters, graphic files and images. The received digital name card data can be saved in the registering medium and/or transmitted to a corresponding external electronic device.

Accordingly, an object of the present invention is to provide a digital transmitting device, which is possible to exchange the name card data quickly and conveniently by way of wireless or wire transmission to eliminate the tedious work of inputting name card data done by the user.

A second object of the present invention is to provide a digital transmitting device, in which the main body thereof at least a proper place thereof can be disposed with at least a connecting part to electrically connect with the transmitting unit with a transmission interface such as USB, IEEE1394, PCMCIA, Serial ATA, IDE and other mini memory card interface to offer multiple application.

A further object of the present invention is to provide a digital transmitting device, in which the main body thereof at least a emitting/receiving part to connect with the transmitting unit with a wireless transmission interface such as infrared, blue tooth, high frequency or other wireless transmitting interface. In consideration of above problems, the inventor creates a combined flash memory card structure that can be connected to the system end adopting a USB interface or be used in products using the dedicated interface of this invention.

### BRIEF DESCRIPTION OF THE DRAWINGS

The present invention can be more fully understood by reference to the following description and accompanying drawings, in which:

FIG. 1 is a perspective view of a digital transmission device of this invention; and

FIG. 2 is a block diagram of the digital transmission device according to the present invention.

### DETAILED DESCRIPTION OF THE PREFERRED EMBODIMENT

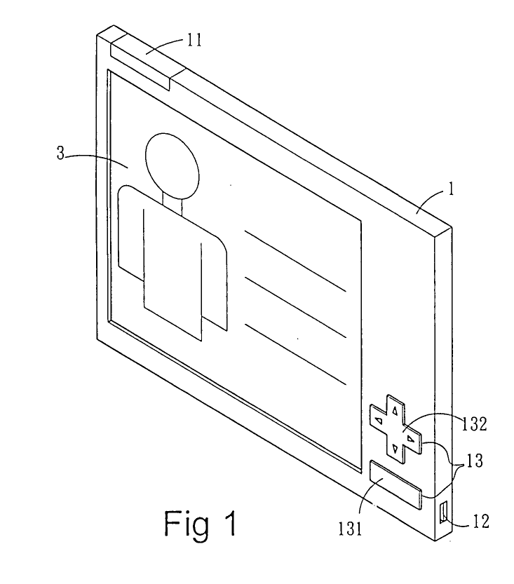

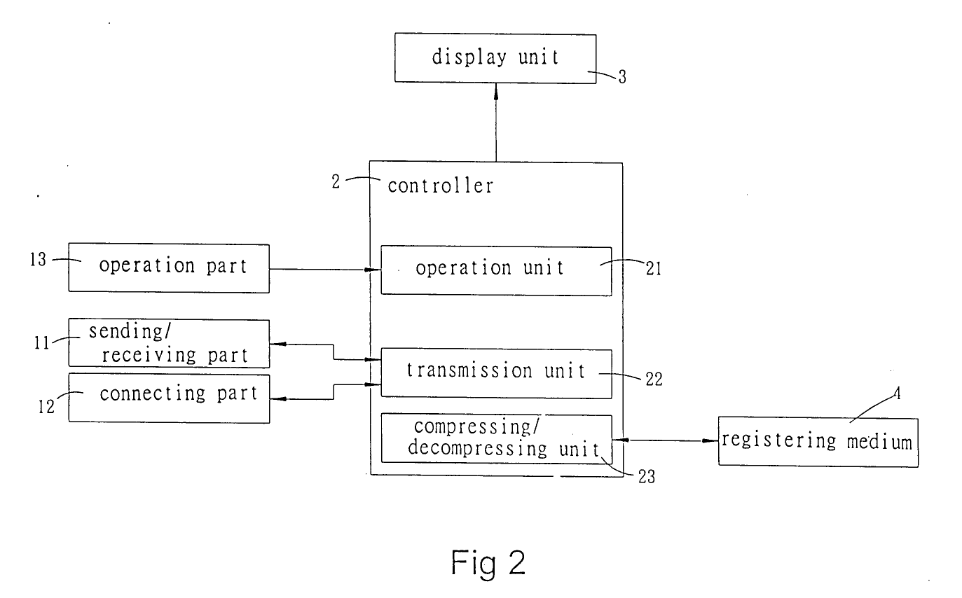

Referring to FIGS. 1 and 2, a digital transmission device of the present invention includes a main body 1, a controller 2, which is associated to the main body 1, a display unit 3 and a registering medium 4. A concept design of super thinness and lightness is involved in the main body 1 for the user being able to carry about with him easily.

The main body 1 can be provided with a sending/receiving part 11 and a connecting part 12 and at a proper area thereof is provided with a display unit 3, which is joined to the controller 2 for displaying data. An operation part 13 is provided at the main body 1 near the display unit 3 and includes at least a receiving/sending key 131, a directional key and etc.

The controller 2 is disposed in the main body 1 for receiving and treating instructions of the operation part 13. The controller 2 includes an operation unit 21 and a transmitting unit 22. The operational unit 21 can identify an input action of the user in accordance with a program and order the controller 2 to perform a related response. The transmitting unit 22 can connect with the sending/receiving part 11 to access with the external device such as a computer, a personal digital assistant (PDA), a mobile phone or other portable electronic device mutually by way of wireless transmission such as infrared, blue tooth and high frequency and/or connect with connecting part 12 to access with the external device mutually by way of wire transmission such as USB, IEEE1394, PCMCIA, Serial ATA, IDE and other mini memory card interfaces. When the transmitting unit 22 receives the transmitting signal, the controller 2 saves the signal in the registering medium 4 and then shows the signal on the display unit 3 or the data stored in the registering medium 4 can be operated through the operation part 13 to allow the transmitting unit 22 transmitting outward.

The registering medium 4 is utilized to store data such as programs, characters and graphic files and the registering medium can built-in flash memory and/or external storage media such as USB drive, compact disk, hard disk and etc.

The digital transmitting device of the present invention can be done with electronic name card data after being edited with the external device is input to the main body 1 first. The electronic name card data is saved in the registering medium 4 via the controller 2 to facilitate management application of name card. When the user intends to exchange name cards with anther person, both of them only need to control the receiving/sending key 131 via the main body 1 and the digital electronic name card data can be transmitted to electronic device of the other side or the same digital transmitting device through the transmitting unit 22, which is belonged to wireless transmission type such as infrared, blue tooth and high frequency in order to facilitate the user carrying about. Further, it is possible to show the name card data of the other side with the display unit 3 and saves the data. In this way, the operation of exchanging the electronic name card data can be done completely.

In practice, the controller 2 is provided with a compressing/decompressing unit 23 to compress data during the process of transmitting to reduce the transmitting capacity largely so as to shorten the transmitting time. After having been received, the compressed electronic data can be unzipped by the decompressing unit 23 and stored in the registering medium 4.

Further, an image picking unit (not shown) can be provided in the main body 1 to be joined to the controller 2 and the image picking unit can be CCD or CMOS to pick up an image such as a half-length photo or portrait of the other side together with the name card data thereof being registered in the registering medium 4 such that the searching time can be shortened to achieve the purpose of quickly searching target electronic name card data.

In addition, the display unit 3 can be designed as a touch pad to replace input function of the operation part so that the user can contact the touch pad with an object such as a finger or a light pen to perform data input or operation.

Furthermore, the digital transmitting device of the present invention can be applied to identification of door security or electronic purse by way of the wireless transmitting function thereof so that the wireless signal of infrared or blue tooth can be sent to a receiving control end for identification check before the signal being able to be sent to the digital transmitting device. In this way, it is possible to integrally join the name card management and the identification of door security or the electronic purse together.

Moreover, the digital transmitting device of the present invention at the transmitting unit 22 thereof is joined with an extended device (not shown) and the extended device can be designed as an input device such as a keyboard or other extended device for input and edit.

It is appreciated that the digital transmitting device of the present invention can reach expected effectiveness and meet design requirement and it is quite different from configuration and feature of a traditional electronic notebook or PDA.

While the invention has been described with reference to the preferred embodiments thereof, it is to be understood that modifications or variations may be easily made without departing from the spirit of this invention, which is defined by the appended claims.

1. A digital transmitting device, comprising:
at least a main body;
a controller, being coupled to the main body;
a display unit, being coupled to the main body; and
a registering medium, being coupled to the main body too;
wherein, the controller further comprises
an input unit, being controlled by the controller to perform an execute instruction; and
a transmitting unit, receiving or transmitting digital name card data such as characters, graphic files and images;
whereby, the received digital name card data can be saved in the registering medium and/or transmitted to a corresponding external electronic device.

2. The digital transmitting device as defined claim 1, wherein the main body can be provided with a sending/receiving part and a connecting part and the display unit is disposed at a place of the main body.

3. The digital transmitting device as defined in claim 2, wherein an operation part is disposed adjacent to the display unit and the operation part at least includes a receiving/sending key and a directional key.

4. The digital transmitting device as defined in claim 1, wherein the transmitting unit is joined to the sending/receiving part to access each other with the external device by way of wireless type such as infrared, blue tooth and high frequency.

5. The digital transmitting device as defined in claim 1, wherein the transmitting unit is joined to the sending/receiving part to access each other with the external device by way of wire type such as USB, IEEE1394, PCMCIA, Serial ATA, IDE and other mini memory card interface.

6. The digital transmitting device as defined in claim 1, wherein the registering medium is used for storing data such as programs, characters and graphic files; the registering medium can be built-in type flash memory and/or external storage medium such as USB drive, compact disk and hard disk.

7. The digital transmitting device as defined in claim 1, wherein the controller is provided with a compressing/decompressing unit to compress data during the process of transmitting and to reduce the transmitting capacity largely so as to shorten the transmitting time and after having been received, the compressed electronic data can be unzipped by the decompressing unit 23 and stored in the registering medium.

8. The digital transmitting device as defined in claim 1, wherein an image picking unit can be provided in the main body to be joined to the controller and the image picking unit can be CCD or CMOS to pick up an image such as a half-length photo or portrait of the other side together with the name card data thereof being registered in the registering medium such that the searching time can be shortened to achieve the purpose of quickly searching target electronic name card data.

9. The digital transmitting device as defined in claim 1, wherein the display unit can be designed as a touch pad to replace input function of the operation part so that the user can contact the touch pad with an object such as a finger or a light pen to perform data input or operation.

10. The digital transmitting device as defined in claim 1, wherein the connecting part can connected to external extended device.
